(19) United States
(12) Patent Application Publication
(10) Pub. No.: US 2009/0225287 A1
(43) Pub. Date: Sep. 10, 2009

(54) RETICLE POD AND METHOD FOR KEEPING RETICLE CLEAN AND DRY

(76) Inventor: Ming-Long CHIU, Shulin City (TW)

Correspondence Address: SINORICA, LLC, 2275 Research Blvd., Suite 500, ROCKVILLE, MD, 20850, US

(21) Appl. No.: 12/210,800

(22) Filed: Sep. 15, 2008

(30) Foreign Application Priority Data
Mar. 6, 2008 (TW) 097107778

(51) Int. Cl. G03B 27/52

(52) U.S. Cl. 355/30

(57) ABSTRACT

A reticle pod and a method for keeping a reticle clean and dry are provided, wherein the reticle pod holds a reticle and has a pellicle side provided with a pellicle. The reticle pod includes: a first cover; a second cover for joining with the first cover to form an inner space for receiving the reticle, in which the second cover has a central region; at least one fixing element on the second cover for supporting and positioning the reticle; at least one gas inlet port on the second cover outside a projection region of the reticle; and at least one gas outlet port on the second cover opposite the gas inlet port with respect to the central region. A gas entering the reticle pod via the gas inlet port flows along the reticle and removes moisture thereon and attached to the pellicle, rapidly lowering a humidity inside the reticle pod.

### BACKGROUND OF THE INVENTION

1. Field of the Invention

The present invention relates to a reticle pod and a method for keeping a reticle clean and dry with the reticle pod.

2. Description of Related Art

Recent years see rapid development of semiconductor technology, including photolithography that plays an important role therein, as photolithography is indispensable to patterning. When it comes to semiconductor, photolithography involves fabricating a transparent reticle with a specific shape in accordance with an intended circuit, and projecting a light source through the reticle to form a specific pattern on a silicon wafer by exposure and development. Any dust and particles (such as microparticles, powder, and organic matter) attached to the reticle can deteriorate the quality of imaging, and thus the reticle has to be kept clean when used in patterning. In general, a wafer process is performed in a clean room to prevent contamination by airborne particles. However, clean rooms nowadays are not absolutely free of dust.

Hence, contamination-free reticle-holding devices, commonly known as reticle pods, for preserving and delivering reticles are used in a semiconductor process nowadays in order to keep the reticles clean during the semiconductor process. During a semiconductor process, a reticle-holding device (hereinafter referred to as a reticle pod) holds a reticle, allows the reticle to be moved and delivered between machines, insulates the reticle from ambient air, and prevents the reticle from contamination and being changed thereby. Hence, advanced semiconductor foundries usually endeavor to assure the cleanliness of standard mechanical interface (SMIF) reticle pods, that is, the reticle pods should have a Class 1 or sub-Class 1 rating for cleanliness. Hence, a gas-fillable reticle pod is one of the solutions in use.

To fill a gas into a reticle pod, the reticle pod must have at least one gas inlet port for connection with a gas-supplying device which supplies the gas to the reticle pod. The present invention provides a reticle pod and a method for keeping a reticle clean and dry, to improve the prior art regarding the position of a gas inlet port of the reticle pod, and regarding a method for introducing a gas into the reticle pod to remove moisture therefrom and carrying contaminated gas away from the reticle pod.

### SUMMARY OF THE INVENTION

The present invention provides a method for keeping a reticle clean and dry and a gas-fillable reticle pod, wherein the reticle pod holds at least one reticle having a pellicle side provided with a frame. The reticle pod comprises: a first cover; a second cover for being assembled with the first cover to form an inner space therebetween for receiving the reticle, wherein the second cover has a central region; at least one fixing element disposed on the second cover for supporting and positioning the reticle; at least one gas inlet port disposed on the second cover and outside a projection region of the reticle; and at least one gas outlet port disposed on the second cover and opposite the gas inlet port with respect to the central region.

It is a primary objective of the present invention to provide a reticle pod wherein a gas enters the reticle pod via a gas inlet port thereof and diffuses in a rippling manner.

Another objective of the present invention is to provide a reticle pod wherein a gas enters the reticle pod via a gas inlet port thereof and removes moisture between a reticle and a pellicle disposed thereon.

Yet another objective of the present invention is to provide a reticle pod, in which a major amount of gas enters the reticle pod via a gas inlet port thereof and flows along a side of a reticle where a pellicle is disposed to substitute for contaminated gas and moisture originating from the pellicle.

A further objective of the present invention is to provide a reticle pod, in which once a gas enters the reticle pod via a gas inlet port thereof, a minor amount of the gas will reach a side of the reticle opposite to where a pellicle is disposed to substitute for contaminated gas and moisture originating from the reticle.

A further objective of the present invention is to provide a reticle pod having a joint element, in which once a gas enters the reticle pod via a gas inlet port thereof, an excessive amount of the gas exits through a gas outlet port or from between the pressure-releasing joint element and the joint element keeps the reticle pod airtight and dust-free when a pressure inside the reticle pod does not exceed a preset value.

### BRIEF DESCRIPTION OF DRAWINGS

FIG. 1 is a perspective view of a reticle pod according to the present invention;

FIG. 2 is a top view showing a second cover of the reticle pod according to the present invention;

FIG. 3 is a side elevation view showing a reticle positioned above the second cover of the reticle pod according to the present invention;

FIG. 4 is a schematic view showing a fastening element optionally provided on the reticle pod according to the present invention;

FIGS. 5A and 5B are schematic views showing a first joint element and a second joint element optionally provided on the reticle pod according to the present invention; and

FIG. 6 is a schematic view illustrating a method for keeping the cleanliness and dry of the reticle according to the present invention.

### DETAILED DESCRIPTION OF THE PREFERRED EMBODIMENT

The present invention discloses a reticle pod and a method for keeping the cleanliness and dry of a reticle. Processes adapted for manufacturing or processing the reticle or the reticle pod are based on the prior art, and thus a detailed description of the processes is omitted herein. In addition, drawings referred to below are not drawn to scale as they are intended to demonstrate features of the present invention only.

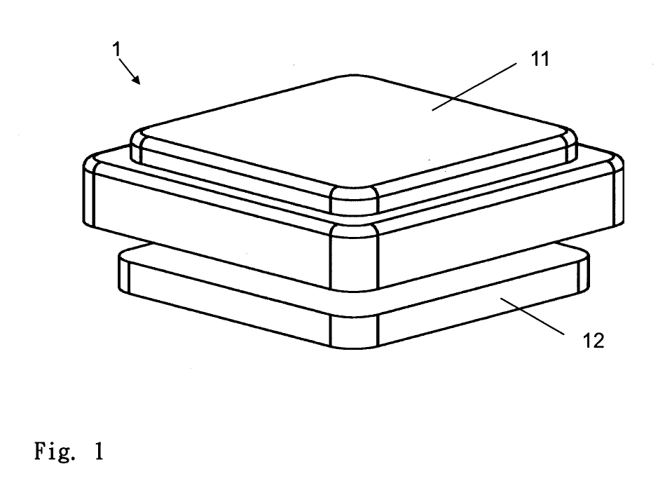

Referring to FIG. 1, which is a perspective view of a reticle pod 1 according to the present invention, the reticle pod 1 includes a first cover 11 and a second cover 12, in which the first cover 11 and the second cover 12 are joined to form an inner space therebetween for receiving a reticle.

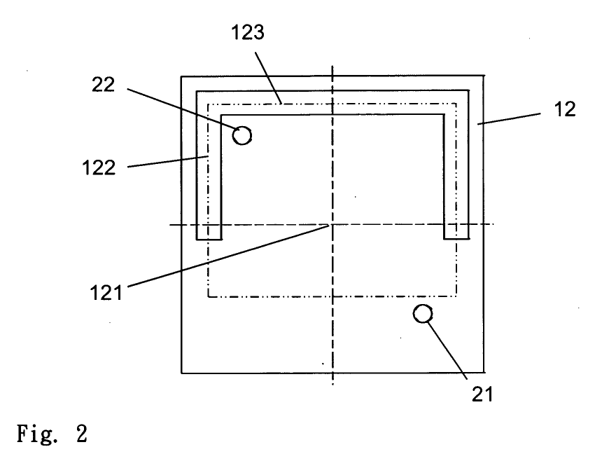

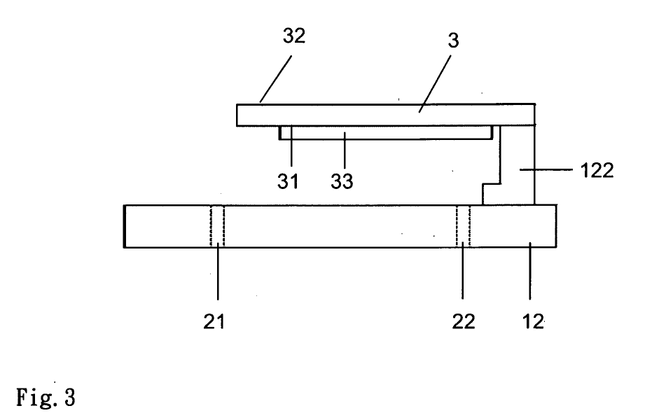

Referring to FIG. 2, which is a top view showing the second cover 12 of the reticle pod according to the present invention, the second cover 12 has a central region 121 centrally disposed thereon. At least one fixing element 122 is disposed on the second cover 12 for supporting and positioning the reticle. At least one gas inlet port 21 is disposed on the second cover 12 and outside a projection region 123 of the reticle, so as to allow a gas to enter the reticle pod 1. At least one gas outlet port 22 is disposed on the second cover 12 and opposite the gas inlet port 21 with respect to the central region 121, so as to allow the gas to exhaust out of the reticle pod 1. Referring to FIG. 3, which is a side elevation view showing a reticle 3 positioned above the second cover 12 of the reticle pod 1 according to the present invention, the reticle 3 has a pellicle side 31 that provided with a frame 33 that prevent the pellicle side 31 from contamination and being changed thereby, and allowing a gas conversion with the gas filled in the reticle pod 1 to remove moisture and contaminants from the reticle 3.

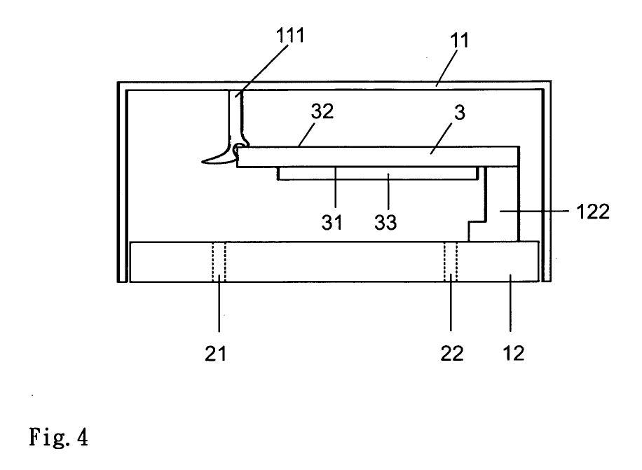

Referring to FIG. 4, at least one fastening element 111 is optionally provided on a side of the first cover 11 facing the inner space so as to support an edge of the reticle 3. An edge of the fastening element 111 itself extends to above the gas inlet port 21, not only to guide a major portion of the gas entering the reticle pod 1 via the gas inlet port 21 to flow towards the frame 33 on the pellicle side 31 of the reticle 3 and thereby carry moisture and contaminants away from the reticle pod 1, but also to guide a minor portion of the gas to flow towards a glass side 32 of the reticle 3 and thereby carry moisture and a contaminated gas away from the reticle pod 1.

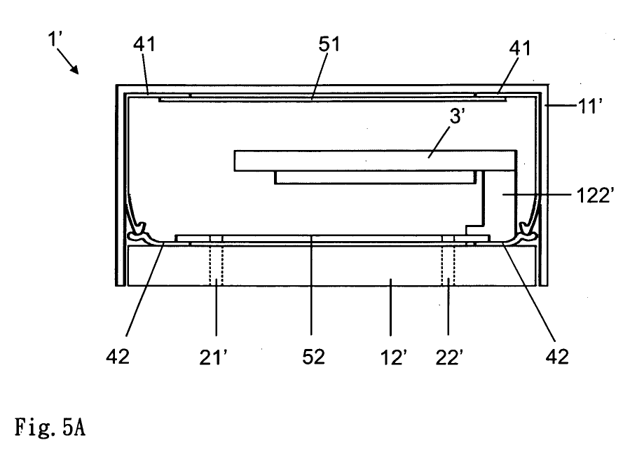

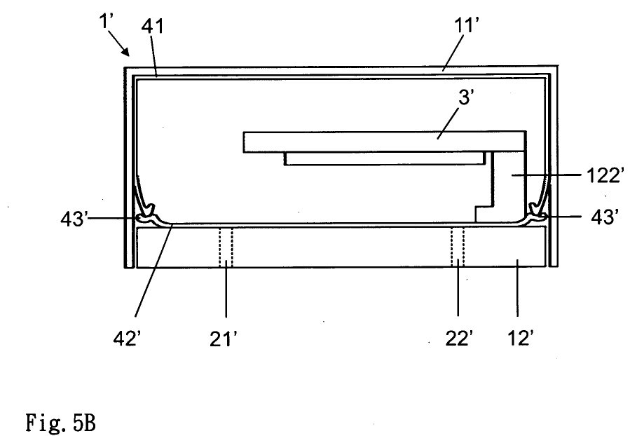

Referring to FIGS. 5A and 5B, a reticle pod 1′ is optionally provided with joint elements 41, 42 for dust prevention. Likewise, the reticle pod 1′ includes a first cover 11′ and a second cover 12′, in which the first cover 11′ and the second cover 12′ are being assembled to form an inner space therebetween for receiving a reticle 3′. At least one fixing element 122′ is disposed on the second cover 12′ for supporting and positioning the reticle 3′. Most importantly, the first cover 11′ and the second cover 12′ are circumferentially solid joint to the first joint element 41 and the second joint element 42 respectively. The joint elements 41, 42 are made of a resilient material. Or alternatively, a joint portion 43 of the second joint element 42 for solid joint with the first joint element 41 is suspended, so that in the event of excessive pressure inside the inner space of the reticle pod 1′ due to an excessive amount of gas therein, the gas will drain out from the middle of the joint elements 41, 42 to maintain an appropriate pressure inside the inner space and prevent the reticle 3′ from damage. If the pressure inside the inner space of the reticle pod 1′ does not exceed a preset value, the joint elements 41, 42 will provide airtight solid joint and keep the reticle pod 1′ airtight, leak-free, and dust-free. Furthermore, the first cover 11′ may be provided with a first plate 51 such that the first joint element 41 is clamped therebetween, as shown in FIG. 5A, while the second cover 12′ may be provided with a second plate 52 such that the second joint element 42 is clamped therebetween, as shown in FIG. 5A. Alternatively, if necessary, the first joint element 41 may be integrally formed with the first cover 11′, as shown in FIG. 5B, while the second joint element 42 may be integrally formed with the second cover 12′, as shown in FIG. 5B.

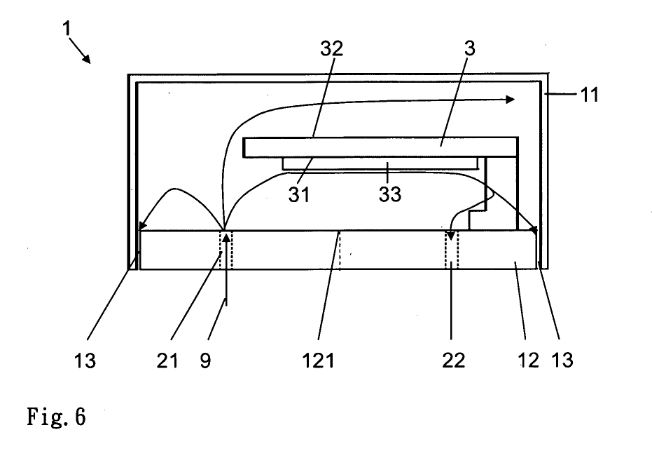

Referring to FIG. 6, which is a schematic view illustrating a method for cleaning and drying a reticle 3 according to the present invention. A pellicle side 31 of the reticle 3 is provided with a frame 33 for preventing the reticle 3 from contamination. The frame 31 absorbed the moisture that is generated from the reticle 3, and the gas is transformed with a gas inside the reticle pod 1 so as to the moisture and contaminants cane be removed from the reticle 3.

First, a reticle pod 1 is provided, which includes a first cover 11; a second cover 12; at least one fixing element 122 that is disposed on the second cover 12 for supporting and positioning the reticle 3; at least one gas inlet port 21; and at least one gas outlet port 22. The second cover 12 has a central region 121 that centrally disposed thereon. The gas inlet port 21 is disposed on the second cover 12 and outside a projection region of the reticle. The gas outlet port 22 is disposed on the second cover 12 and opposite the gas inlet port 21 with respect to the central region 121.

Then, the reticle 3 is disposed on the fixing element 122 and the pellicle side 31 is provided for the frame 33 of the reticle 3 is disposed toward the second cover 12. Thus, the first cover 11 is jointed tightly with the second cover 12, and the gas is flowed into the reticle pod 1 and diffused over the reticle pod 1 via the rippling. Amount of gas is flowed through the pellicle side 31 that is provided for the frame 33 of the reticle 3 to replace the contaminated gas and the gas is exhausted outside from the gas outlet port 22 to remove the dust and the moisture. Otherwise, the gas can be exhausted outside from the gap 13. Also, the gas would flow through the glass side 32 of reticle 3 without the frame 33 to remove the dust and the moisture. Alternatively, the gas would not flow through the reticle 3, but is exhausted outside from the gap 13 of the reticle pod 1 directly

The above description in intended to illustrate the preferred embodiment of the present invention and did not to limit the scope of the present invention. Moreover, as the content disclosed herein should be readily understood and can be implemented by a person skilled in the art, all equivalent modifications and variations made thereby without departing from the spirit of the present invention should fall within the scope of present invention defined by the appended claims.

What is claimed is:

1. A gas-fillable reticle pod for storing at least one reticle, wherein the reticle has a pellicle side provided with a frame, the reticle pod comprising:
a first cover;
a second cover for being assembled with the first cover to form an inner space therebetween for receiving the reticle, wherein the second cover has a central region;
at least one fixing element disposed on the second cover for supporting and positioning the reticle;
at least one gas inlet port disposed on the second cover and outside a projection region of the reticle; and
at least one gas outlet port disposed on the second cover and opposite the gas inlet port with respect to the central region.

2. A gas-fillable reticle pod for storing at least one reticle, wherein the reticle has a pellicle side provided with a frame, the reticle pod comprising:
a first cover;
a second cover for being assembled with the first cover to form an inner space therebetween for receiving the reticle, wherein the second cover has a central region;
at least one fixing element disposed on the second cover for supporting and positioning the reticle;
at least one gas inlet port disposed on the second cover and outside a projection region of the reticle;
at least one gas outlet port disposed on the second cover and opposite the gas inlet port with respect to the central region; and
at least one fastening element disposed on a side of the first cover facing the inner space so as to support an edge of the reticle.

3. The gas-fillable reticle pod of claim 2, wherein an edge of the fastening element extends to above the gas inlet port.

4. A gas-fillable reticle pod for storing at least one reticle, wherein the reticle has a pellicle side provided with a frame, the reticle pod comprising:
a first cover;
a second cover for being assembled with the first cover to form an inner space therebetween for receiving the reticle;
at least one fixing element disposed on the second cover for supporting and positioning the reticle;
a first joint element fixedly connected to a periphery of the first cover; and
a second joint element fixedly connected to the second cover for joint with the first joint element, wherein a joint portion of the second joint element for joint with the first joint element is suspended.

5. The gas-fillable reticle pod of claim 4, wherein the first cover is provided with a first plate such that the first coupling element is clamped therebetween.

6. The gas-fillable reticle pod of claim 4, wherein the second cover is provided with a second plate such that the second joint element is clamped therebetween.

7. The gas-fillable reticle pod of claim 4, wherein the first joint element is integrally formed with the first cover.

8. The gas-fillable reticle pod of claim 4, wherein the second joint element is integrally formed with the second cover.

9. A method for keeping a reticle clean and dry, wherein the reticle has a pellicle side provided with a frame for protecting the reticle from contamination, the method comprising steps of:
providing a reticle pod comprising:
a first cover;
a second cover for being assembled with the first cover to form an inner space therebetween for receiving the reticle, wherein the second cover has a central region;
at least one fixing element disposed on the second cover for supporting and positioning the reticle;
at least one gas inlet port disposed on the second cover and outside a projection region of the reticle; and
at least one gas outlet port disposed on the second cover and opposite the gas inlet port with respect to the central region;
positioning the reticle on the fixing element, so that a side of the reticle where the pellicle is provided faces the second cover;
joining the first cover with the second cover; and
introducing a gas into the reticle pod via the gas inlet port such that the gas flows along an entirety of the side of the reticle where the pellicle is provided, removes dust and moisture from the pellicle, and exhaust through the gas outlet port opposite the gas inlet port.
